(19) United States
(12) Patent Application Publication
(10) Pub. No.: US 2026/0045154 A1
(43) Pub. Date: Feb. 12, 2026

(54) RETAIL MONITORING SYSTEM

(71) Applicant: SENNCO SOLUTIONS INC., PLAINFIELD, IL (US)

(72) Inventors: Dale R. Liff, Coshocton, OH (US); Brian PEACOCK, Melbourne, FL (US); Christopher Alan MARSZALEK, Plainfield, IL (US)

(73) Assignee: SENNCO SOLUTIONS INC., PLAINFIELD, IL (US)

(21) Appl. No.: 19/364,303

(22) Filed: Oct. 21, 2025

Related U.S. Application Data
(63) Continuation-in-part of application No. 18/219,917, filed on Jul. 10, 2023, now abandoned.
(60) Provisional application No. 63/359,476, filed on Jul. 8, 2022.

(51) Int. Cl. G08B 13/14

(52) U.S. Cl. CPC G08B 13/1436

(57) ABSTRACT

A store monitoring system and method for reducing theft in a retail environment. The monitoring system includes a central control unit including a user interface and a plurality of configurable product availability and/or anti-theft devices connected with respect to the central control unit. The user interface allows the configurable anti-theft devices to be monitored, as well as adding, removing, moving, changing, and/or modifying devices. In the user interface, the anti-theft devices can be identified by location within the retail environment, or by the associated retail product.

### CROSS REFERENCE TO RELATED APPLICATION

This application is a continuation-in-part of U.S. Ser. No. 18/219,917, filed on 10 Jul. 2023, which claims the benefit of U.S. Provisional Patent Application, Ser. No. 63/359,476, filed on 8 Jul. 2022. The co-pending provisional application is hereby incorporated by reference herein in its entirety and is made a part hereof, including but not limited to those portions which specifically appear hereinafter.

### BACKGROUND OF THE INVENTION

### Field of the Invention

This invention relates generally to a retail protection system and, more particularly, to a system that protects and monitors items on retail shelves.

### Description of Prior Art

A growing problem for retail stores is shoplifting and other theft of high value inventory directly from shelves. Traditionally, thieves have shoplifted high value items in low quantities, one visit at a time. Another newer technique thieves employ is to target retail stores to “sweep” shelves of valuable product by quickly assembling and removing as much of the product as possible. The thieves then exit the store with the product before store personnel or law enforcement have an opportunity to react. The product is either later returned for cash or sold outright.

Solutions to this problem have included locking down high value product in vaults or cabinets that require store personnel to unlock and physically provide the product to the consumer. Other solutions include security wires that physically connect the product to store shelves or each other. These solutions also require store personnel to unlock and untether such product for the consumer. These solutions tend to discourage customers from purchases because of the extra effort and time required to attain a product for purchase.

Other solutions utilize mechanical dispensers connected to shelves that are configured to mechanically dispense one product at a time before resetting for dispensing another product. These solutions are not flexible for a variety of inventory and this inflexibly requires particular store shelves to be dedicated to particular inventory.

Such solutions create bottlenecks of consumers trying to obtain goods for purchase as they wait for assistance or help themselves amid fixtures that are designed to stop or deter illegitimate customers. These bottlenecks may ultimately deter legitimate shopping and thereby reduce retail sales.

A continuing need exists in a retail system to monitor store shelves and permit store staff to assist customers and identify when certain departments of a retail store and/or specific shelves are being accessed by customers while also enabling shoppers to examine and purchase product unencumbered by lock and key solutions.

### SUMMARY OF THE INVENTION

The invention generally relates to a retail store monitoring system that can be incorporated with retail anti-theft devices to maintain and monitor goods.

The general object of the invention can be attained, at least in part, through a system of interconnected sensors, locks, call buttons, gates, safes, cabinets and/or other equipment that creates a trackable retail environment permitting staff to respond to customers directly and in person or through additional electronic inputs. The system further generates and tracks data related to the above sensors and responses.

In embodiments of this invention, the system allows for establishing and receiving custom alerts in store, wirelessly/remotely lock down locking anti-theft devices individually, by area or category, or fully, remotely changing sensor alerts (e.g., messages) and functions, monitoring battery life, adding or removing anti-theft devices, displaying event history for each anti-theft device, and/or customizing press sequences or triggers.

The invention includes a store monitoring system for a retail environment. The monitoring system includes a central control unit including a user interface and a plurality of configurable anti-theft devices connected with respect to the central control unit. Each of the plurality of configurable anti-theft devices is added, removed, moved, changed, and/or modified through the user interface. The plurality of configurable anti-theft devices include combinations of sensors, locks, call buttons, gates, safes, and retail cabinets distributed throughout a retail store, and the user interface monitors and displays operation data related to the plurality of configured anti-theft devices.

The invention further includes a store monitoring system for a retail environment that includes a plurality of configurable anti-theft devices and a central control unit including a user interface and in wireless connection with each of the plurality of configurable anti-theft devices. Each of the plurality of configurable anti-theft devices is added, removed, moved, changed, and/or modified through the user interface. Each of the plurality of configurable anti-theft devices is added for display within the user interface by association with: a unique identification number, and an anti-theft category selected from a device type and/or a corresponding retail product type. Information about each of the plurality of configurable anti-theft devices is stored in the central control unit and displayed in the user interface by both the device type and/or the associated retail product type.

The invention further includes a method of securing products in a retail environment. The method including steps of: associating one or more products with an anti-theft device in wireless connection with a central control unit including a user interface; and identifying the anti-theft device with and anti-theft category selected from device type, retail product type, and/or product location within the retail environment.

In embodiments of this invention, the user interface is configured to monitor and control the plurality of configurable anti-theft devices and allow retail users (e.g., employees) to respond to customers and alerts from the each of the plurality of configurable anti-theft devices directly and in person or through additional electronic inputs.

In embodiments of this invention, each of the plurality of configurable anti-theft devices includes a unique identification stored within the central control unit. Each of the plurality of configurable anti-theft devices is desirably also assigned a retail category according to a location within the retail environment. Each of the plurality of configurable anti-theft devices is desirably assigned a retail category as a function of a position within the retail environment, and the retail category and/or the position is accessible within the user interface. Exemplary retail category include jewelry, fragrance, electronics, tools, medicine, weaponry, pharmacy, and/or a specific product brand. More specific product categories can include razors, condoms, cold/allergy medicine, ammunition, smartphones, power drills/saws, etc.

In embodiments of this invention, the user interface is accessible on each of a plurality of portable access devices (e.g., slave mobile electronic devices) useable throughout the retail environment. In embodiments of this invention, the user interface delivers status alerts received from one or more of the configurable anti-theft devices to one or more of the plurality of access devices. The configurable anti-theft devices can include a call box adapted to be placed within the retail environment, wherein activation of the call box signals a location of the call box to at least one of the plurality of access devices. The call box activation can be ended by a retail worker through the call box or one of the plurality of access devices. In additional embodiments, the configurable anti-theft devices include an electronic lock adapted to be placed within the retail environment, and the electronic lock can be latched and unlatched via at least one of the plurality of access devices.

In embodiments of this invention, a system call button can send a local alert, public announcement and/or a Zebra notification specific to each call button. If a product is locked up and not accessible to a shopper, this low-cost feature is a tool to recapture lost sales without modifying the current infrastructure or sales strategy.

In embodiments of this invention, the system will notify if a cabinet door is opened without authority (or broken into). This gives the store more time to implement their protocol for a theft event. Or the system can notify the team members to stay away from a potentially dangerous situation.

In embodiments of this invention, the system notifies if a door is left open and the merchandise inside is no longer protected.

In embodiments of this invention, the system is integrated with current store system assets such as public announcement systems, handheld devices, closed circuit video systems, PVMs, or other cameras.

In embodiments of this invention, the system provides an additional layer of accountability for store associates. Each store key handed out can be assigned to an associate and monitored for visibility. This can help eliminate internal theft.

In embodiments, the system is ‘self-healing,’ in that it resets after each anti-theft device opening and closing.

The system and/or anti-theft devices of this invention can include product display inventory monitoring and reporting features. In embodiments of this invention, the retail product monitoring system includes one or more sensors for detecting a product availability on one or more retail product displays. The sensor can be connected to any suitable retail display, such as a shelf, cabinet, or a moveable product pusher. The sensor can determine the product availability as a function of a distance between the product and a front or back of the display and/or a movement of, for example, the product pusher. The central control unit can include a user interface configured to receive sensor information and display or alert a low inventory indication and/or a current number of product items on the retail product display.

In embodiments, the sensor includes a first sensor and a second sensor, such as enclosed in a housing. The housing is connectable (e.g., adhered, clipped, or fastened) to a moveable product pusher of the retail product display, but can also be integrated to the pusher or product display. The first sensor determines an empty retail product display, and a second sensor determines a distance from a front or rear of the retail product display. In embodiments, the first sensor comprises a Reed switch and the second sensor comprises a time-of-flight (TOF) sensor. In embodiments, the sensor includes a triggering magnet, such as disposed at a front of the retail product display.

### BRIEF DESCRIPTION OF THE DRAWINGS

Other objects and advantages will be apparent to those skilled in the art from the following detailed description taken in conjunction with the appended claims and drawings, wherein:

FIG. 1 shows a schematic of a retail monitoring system according to one embodiment of the invention;

FIG. 2 shows a call button used in connection with a retail monitoring system according to one embodiment of the invention;

FIG. 3 shows a schematic of a cabinet used in connection with a retail monitoring system according to one embodiment of the invention; and

FIGS. 4-7 show a user interface used in connection with a retail monitoring system according to one embodiment of the invention;

FIG. 8 shows a stock sensor on a product pusher, according to one embodiment of the invention;

FIGS. 9 and 10 show a stock sensor according to one embodiment of the invention; and

FIG. 11 shows a user interface used in connection with a retail monitoring system according to one embodiment of the invention.

### DETAILED DESCRIPTION OF THE INVENTION

The present invention provides a system including a series of sensors that can be mounted relative to retail shelves, fixtures, doors, safes, and other locations to monitor inventory and/or prevent theft of various items.

The invention provides a suite of monitoring options including call buttons (with multiple paging and response options), team member pocket buttons, receiving doorbells, door sensors (e.g., entrance doors, cabinet doors, locking showcase doors), safe sensors, swing gate and swing gate mini sensors, employee keys or key cards, and other integrations. When an event is triggered, the system provides optional and customized notifications via local audio, public announcement audio, Zebra notifications, text or email alerts, closed circuit tv integration, and/or silent alerts to local authorities.

The subject system, termed ViziTECH®, may work in connection with other systems developed by the applicant including Bricktech®, the subject of U.S. Publication US2021/0334925, which is incorporated herein by reference, and/or a lockable and/or latchable security gate solution, the subject of U.S. Publication US20210106148, which is incorporated herein by reference.

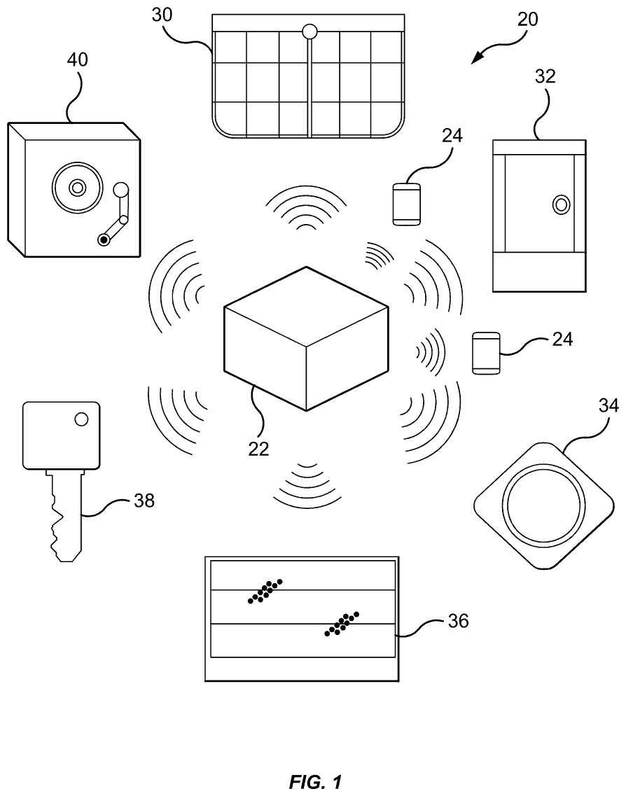

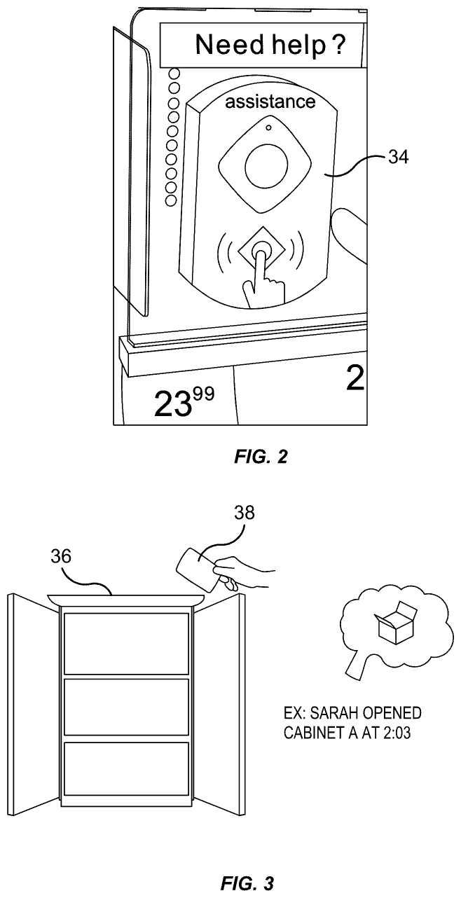

FIG. 1 schematically shows a system 20 according to one embodiment of this invention, and which is desirably installed in a retail store environment in the form of a base control unit 22 and a plurality of anti-theft devices (e.g., sensors) positioned among store fixtures. The system 20 permits store employees to receive customer alerts in store or via e-mail, Zebra or text, such as via mobile electronic devices 24 (e.g., phones, tablets, or other dedicated slave devices, etc.). Exemplary anti-theft device types include, without limitation: swing gates 30, door sensors and/or locks 32, call buttons 34 (see also FIG. 2), display/cabinet/shelf sensors and/or locks 36 (e.g., including freezer/refrigerator sensors), key or key card sensors 38 (see also FIG. 3), and safe sensors 40. The base control unit can be any suitable computer system, with a suitable data processor, non-transient recordable medium, and software instructions executable to implement the user interface and methods herein.

Each wireless anti-theft device according to a preferred embodiment includes a unique fixed identification so once they are configured in the system, the anti-theft device identification and other info is pushed back down to the control unit 22 and stored in a local database so the control unit 22 knows how to handle the anti-theft device and what audio/text/email alerts to send locally and remotely according to the anti-theft device type and category. Categories are easily assigned to each sensor as well as customizable alerts. Some example sensor categories include: jewelry; cosmetics; grocery; tools; delivery door (open and/or doorbell button); specific trademark or brands such as RED BULL or DURACELL; and others.

Gate sensors 30, such as those used in connection with security swing gates as described in U.S. Publication US20210106148 (incorporated herein reference) may include the following activity: 1) normal gate open with no sweep event detected: doorbell chime and strobe will trigger; 2) sweep event detected (X openings in XX seconds, i.e., 3 opens in 15 seconds): siren alarm, strobe, and mobile alert; 3) additional sweep events within 1 minute of the original sweep event will not trigger siren alarm, strobe, or mobile alert; 4) when a gate is left (stuck) open, a supervise chime is played every X minutes, such as every 70 minutes; and 5) in a preferred embodiment, a key sensor does not affect the functionality of the gate sensors.

One or more anti-theft devices of the system may include manual learning. For example a gate sensor may be “taught” a routine by opening and closing the gate within a designated time period, e.g., open and close a gate 10 times within approximately 50 seconds (open to open within 5 seconds). Then the gate may be opened again and receive a verification through a chime and/or strobe to confirm learning to the system.

According to one embodiment of the subject system, cabinet sensors may be positioned with respect to sliding and/or swinging cabinet doors within a retail environment. The protocol may include the following: 1) a normal cabinet open: siren alarm, strobe, and/or mobile alert will trigger; 2) when a cabinet is left (stuck) open, a siren alarm, strobe, and/or mobile alert will be triggered every X seconds, e.g., every 90 seconds; 3) rearming, the system will rearm when all the cabinets are closed, or X seconds (e.g., 90 seconds) after a last key swipe.

In addition to the sensors, and as shown in FIG. 3, an electronic key or key card 36 may be used by store employees to unlock, lock, engage, and/or disengage the sensors described herein. Functionality of such keys may include: 1) ‘swipe’ the key to disarm the system (note: X seconds for cabinet sensors, e.g., 90 seconds) when all cabinets are closed; 2) when a cabinet is opened and closed during this time and all other cabinets are closed, the system will re-arm; 3) no cabinets will trigger the siren alarm or strobe during the X second disarm time unless the system re-arms before that X seconds; 4) the system will re-arm cabinet sensors X seconds from the key swipe; and 5) any additional key swipes will reset the disarm to X seconds.

According to one preferred embodiment, safe sensors 38 may be utilized as follows: 1) a normal safe open: no siren alarm, strobe, or mobile alert are triggered; and 2) when a safe is left or stuck open, a siren alarm, strobe, and mobile alert will be triggered every X minutes, e.g., 5 minutes. In connection with the operation of safe sensors 38, an electronic key 36 may likewise be used and may include the following functionality: 1) ‘swipe’ the key 36 to disarm the system (note: X minutes for safe sensors 38, e.g., 5 minutes) when all safes are closed; 2) no safe alerts will trigger within X minutes from the last key swipe; and 3) after X minutes the safe sensors will re-arm.

As partially described above, a call button 34 as shown in FIG. 2 may be used to send a message within the platform and permit an associate to attend to a customer and then either disable the button 34 with a touch or use an electronic key or magnet to send another signal that the call has been addressed. Serialization or identification may be used in association with the electronic key described herein to provide data about which employee answered the call and within what amount of time.

Another sensor type that may be used in connection with the subject system is a battery powered wireless e-latch (lock). Such an e-latch may be added and configured like any other sensor in the system and provide status when a gate, door, or cabinet is opened or closed, but also enable sending commands to the latches to lock or unlock them on demand, automatically based on schedule, or automatically based on system events. These latches can also be logically coupled with call buttons for example if power tools are locked in a cage, but a call button near the cage is pressed to alert the store associates, the cage can be unlocked on demand through a graphical user interface, and preferably a web user interface (UI) or automatically by the system.

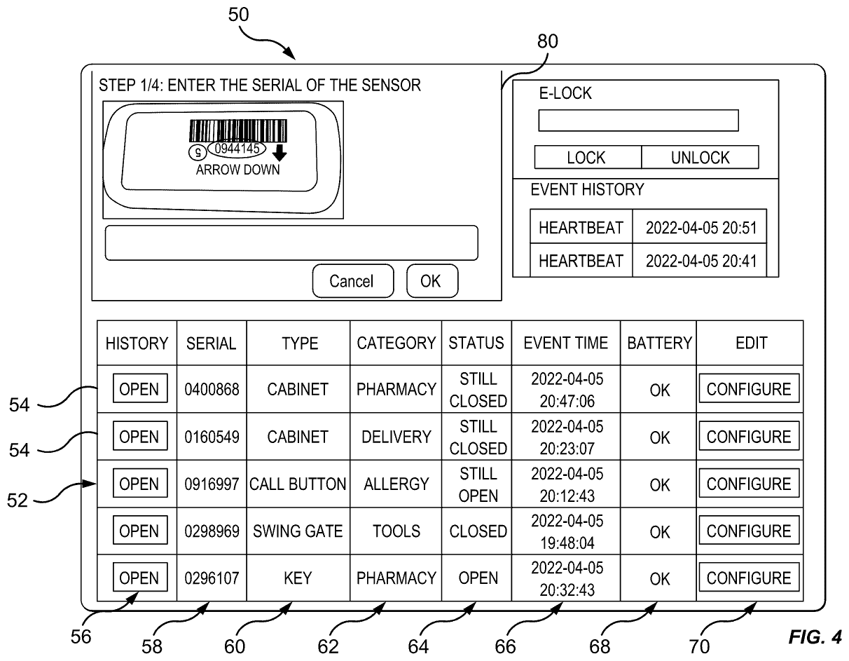

As shown in FIGS. 4-7, the subject system preferably includes a UI 50 that allows store employee end users to very easily add, remove, and configure sensors, sensor types, sensor categories, and the corresponding audio/text/email alerts associated with sensor events. The UI 50 includes several windows, each embodying and displaying information related to several functionalities of the system. Referring to FIG. 4, the UI 50 includes record listing 52 of each anti-theft device registered in the system. Each device is listed in a row 54, and includes a link 56 to the device history (e.g., event history, such as when open, how long, and by whom). Each device is identified by a serial number 58, device type 60, and a category 62. The category 62 reflects the position of the device within the retail environment, and can be a place (e.g., font/back, etc.) a general product type (e.g., jewelry, pharmacy, etc.), or a particular brand (e.g., the CLARATIN cabinet). The UI 50 further includes a current event status 64 along with a time indicator 66 since the last status change. Each device record further includes a real-time or periodically checked battery status 68. The IU further includes a configuration link 70 which opens a window to modify the listing of the device, such as, without limitation, to change the category or other information.

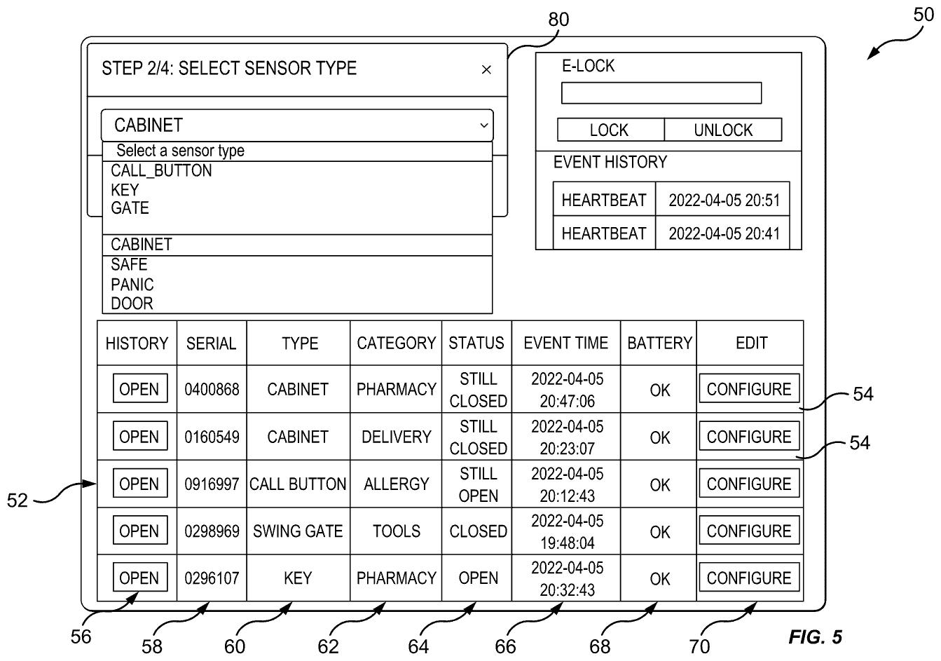

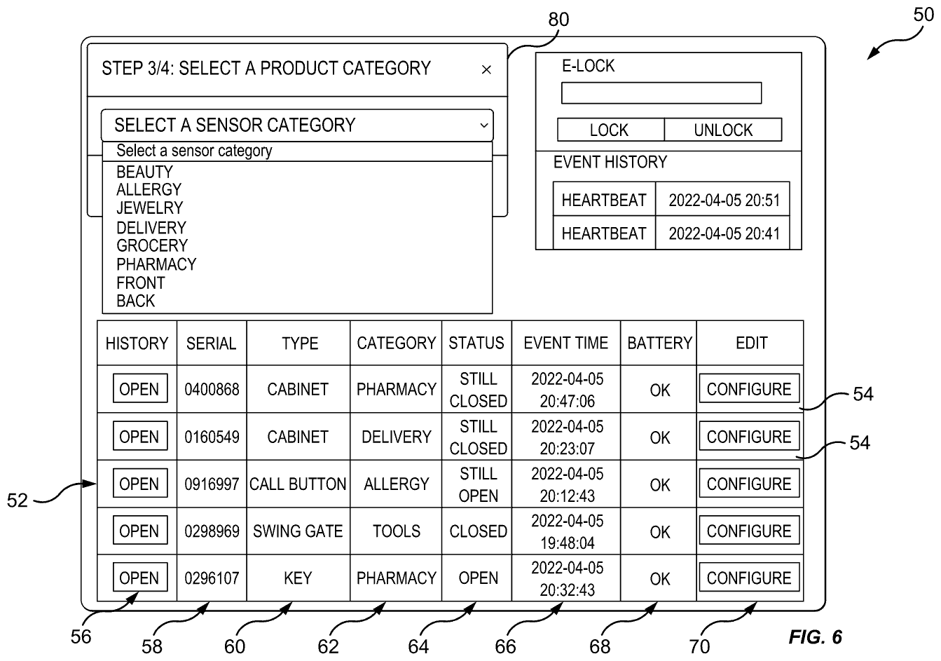

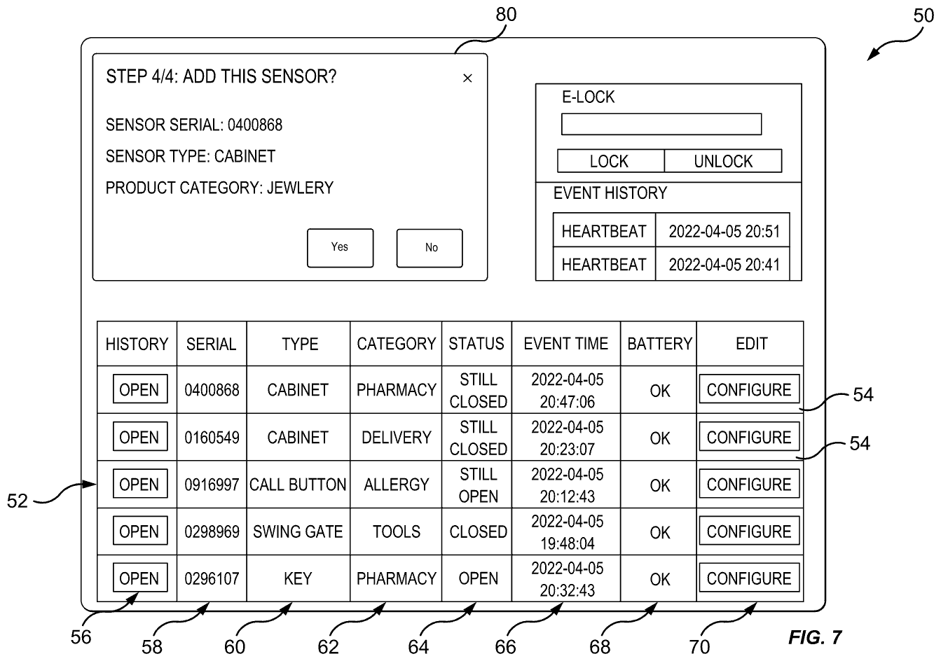

Window 80 shows a first step in adding a new anti-theft device 50. The first step involves entering the identification number of the device, shown in FIG. 4 as a serial number. The system can then wirelessly connect to the sensor using the serial number, and any other access information (e.g., access code or password). In FIG. 5, step two of the new device setup includes selecting a sensor type, such as from a predetermined type selection list as shown. In FIG. 4, the device shows a sensor, and in FIG. 5 the sensor is associated with a cabinet. FIG. 6 shows the next step of selecting a product type associated with the cabinet/sensor, also being selected from a predetermined list of product types. FIG. 7 confirms the sensor setup for a cabinet in the jewelry department. Once the user confirms the sensor, the sensor will be added as a row 54 in the record listing 52. A similar process, without needed to initially identify the device, is repeated to reconfigure a device using the configuration link button 70.

In embodiments of this invention, the central control unit 22 wirelessly receives event messages from devices/sensors throughout the store. The control unit 22 is preferably Internet of Things (IoT) connected to a cloud server “back end” via ethernet, Wi-Fi, or cellular. The cloud server stores data event information from the system and also provides an IoT connection for a web user interface (Web UI) through a secure URL link. Using the Web UI, end users i.e., store owners and/or employees) can view the store's system including a list of currently configured devices, device status, and device history data. Using the Web UI, such as shown in FIGS. 4-7, authorized end users can easily add, remove, and configure different devices, device types, and device categories.

The subject system of embodiments of this invention, such as shown in FIG. 1, may further includes slave electronic devices 24, such as slave ANDROID devices, that would/could: need a Wi-Fi connection (or active SIM card) to monitor and communicate with them; be directly connected to a (nearby) control unit 22 over Bluetooth so even if the network is down they can send alerts; include active or passive monitoring software or hardware such as BricTECH installed on them to monitor them, make sure they are powered, and secure them; be attached to a set of USB powered speakers if needed so the audio can cover a larger category/area.

The slave devices 24 may be low-cost phones or tablets that could be concealed inside a box for added security or could be visible so content can be displayed on their screens—for example if securely mounted near/with a call button, when the button is pressed the system could notify with audio and also put active messaging on the screen then change the audio and message when the call is serviced. A call service feedback may be included to require the associate to click a button on the screen so the device sends another alert out to the system to show that the call has been serviced. Such devices supplied to customers would need to be very rugged and secured (like with an HDLD) because of the potential for breakage or theft.

Such devices can also display targeted advertising related to the product sought or a related product as the customer awaits assistance from store personnel. Such advertising may also include coupon codes or discount information related to the product category.

The devices will generally require a custom application or DPC running on them that receives the alerts from the system and plays the audio/video messages. These devices may be configured into the system by serial and category just like any other sensors in the system. The custom application or DPC could also eventually be used by store associates on their own devices if they are enrolled and added as “sensors” in the system.

Prior art systems used in-store local radios or walkie-talkies but did not utilize public address systems and/or localized speaker integration. Such systems may include a call button that blinked following activation with an internal speaker that announces an instruction such as “a store associate will be right with you.” To clear the blinking light, a customer or an association can hold the button down again.

The call buttons according to one embodiment of the subject system may include color coordinated call buttons above to identify them by category or area of the store, if needed. In embodiments of the invention, a separate ANDROID device is included nearby or in place of the call button device for local messaging for that designated area. Example retail areas and categories may include: condom lock-up; fragrance lock-up; car replacement light bulbs lock-up; PIONEER radio and speaker lock-up; gun counter; paint counter; and baby formula lock-up. These example categories are in different aisles from one another. So one ANDROID device may be installed in the area to broadcast the need. It would be attached to a post or fixture that has power to it.

In such a system, an inexpensive slave device, such as a smartphone may be positioned in place of or near the call button and connected to WIFI. When the call button is pressed it will send a message to the stores associate device for notification and to the slave smartphone in the area. Over these devices a message would announce “customer needs assistance in fragrance”. When the associate comes to assist, the call button is pressed for a designated time period or for a series of repeated depressions and a second message goes out to associates announcing or reading “fragrance customer has been helped.” Likewise, over to the local slave device “fragrance customer has been helped”.

The system as described can enable store employees or remote management to lock and unlock the store by category (all locks in a certain section or aisle); lock or unlock everything in the store; lock or unlock based on events (such as sweep events); lock or unlock based on a timed schedule (e.g., lock during scheduled break times and/or off hours); and/or lock or unlock when a call button is depressed.

Sensors/devices and corresponding displays and/or slave devices may be programmed to receive custom alerts, remotely change message and function on demand; see current battery life; add or remove sensors; see event history; customize sequences and triggers; and other real time or programmable customization.

In summary, the subject system only requires a single access to network connectivity. This greatly improves reliability in a retail environment and reduces overall total cost of ownership. The control unit monitors all sensors in a store independently of other wireless networks and systems in the environment. The control unit is the only device that needs a secure Wi-Fi, Ethernet, and/or cellular network connection and power. The system can operate in local-only mode without a network connection required.

The control unit supports an unlimited number of wireless battery-powered sensors. Each device or sensor preferably includes a unique identification and generally can operate from 3 to 8 years between battery replacement depending on the type of device or sensor. Sensors generally use standard coin cell batteries, which can be replaced simply and inexpensively in the field.

The anti-theft devices operate on dedicated security bands which will not be effected by cell phones, mobile radios, wireless intercom systems, Wi-Fi, Bluetooth, LoRA, Zigbee, or other wireless devices commonly found in retail environments. control unit 22 provides optional and customized notifications via local audio, public address audio, Zebra notifications, text or email alerts, closed circuit TV integration, and more.

The subject system includes the ability to use the Team Member Button to trigger a “panic” response to initiate a silent alarm when a high-risk situation occurs (robbery, violent event, armed intruder, etc.). The system collects and stores all data, events, and alerts which can be accessed and downloaded via web portal or Cloud. Additional exception reporting activity within a store is available including: how many times a call button was triggered by a department within a store; device traffic in areas in which motion sensors are deployed. Additional time-stamped data can be used to evaluate staffing needs and response times.

Remote ongoing system checks are enabled as well as monitoring through collected data. The system detects and reports faulty devices, system failures, low battery, offline systems, etc. The system software platform is designed to simplify the internal troubleshooting and maintenance of the system thereby minimizing the need for technicians and additional labor onsite.

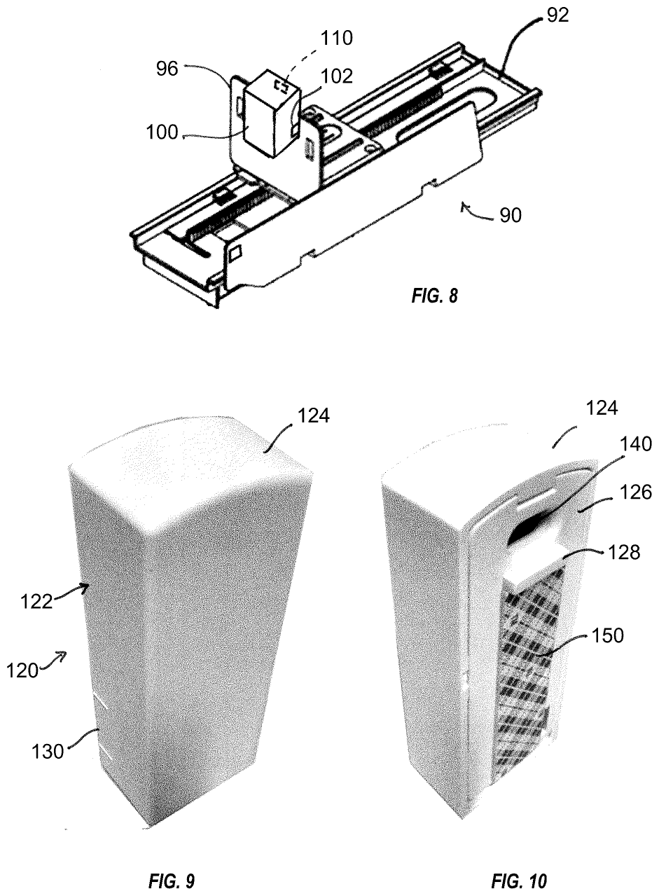

FIGS. 8-11 show additional configurable product detection and/or anti-theft devices according to embodiments of this invention. As illustrated, the configurable anti-theft devices are on shelf availability sensors for determining that shelves or displays are low and/or out of product and need to be restocked (hereinafter “OSA sensors”). Embodiments of these OSA sensors are particularly useful with retail product displays having a system or component designed to move products forward in the display upon removing the front product for purchase.

OSA sensors of this invention provide retailers with micro-visibility into their on-shelf inventory. Designed for seamless integration with existing product pusher systems, the OSA sensors offer real-time insights into product levels at any given moment. In addition, beyond simply tracking quantity on a shelf, the OSA sensors can detect and alert retailers of sweeping theft events and even trigger automated functions such as reordering, ensuring shelves remain fully stocked. The OSA sensors empower retailers to optimize inventory management, minimize out of stocks, and enhance the overall customer shopping experience.

FIG. 8 shows an exemplary product dispensing system 90, also known as a “pusher,” according to one preferred embodiment. The product dispensing system 90 has a tray 92 on which products may be inventoried. The tray 92 may be arrayed within a housing and restocked through a door (neither shown) by a store employee. The tray 92 preferably includes a line of products for dispensing on a per unit basis from the overall product dispensing system. FIG. 8 shows an OSA sensor 100 according to embodiments of this invention that determines when the product pusher 96, or a product pushed thereby, reaches a predetermined position that indicates more product needs to be added. As will be appreciated, the type, size, and position of the OSA sensors can vary depending on the tray 92 and/or product pusher 96, and can be configured to continually indicate how many products are remaining, indicate when a tray or lane is fully empty, and/or indicate when a chosen low inventory is reached (e.g., 1-3 product packages). As an example, the OSA sensor can be positioned on the rear side of the pusher as well. In other embodiments, the OSA sensor is integrated with a product dispenser, thereby not requiring separately installed components.

The OSA sensor 100 includes a first sensor 102 that operates in combination with a magnet element 104 placed at the front of the pusher system 90. The placement of the magnet element 104 is such that the first sensor 102 is triggered reliably when the pusher 96 is emptied of all stock. As illustrated, the OSA sensor 100 includes a second sensor 110 that determines a range from a rear of the product dispensing system or the corresponding housing or retail display (e.g., cabinet or shelf, etc.). The OSA sensor 100 is positioned on the pusher 96 so that the second sensor 110 is above the top edge of the product pusher 96.

Various and alternative configurations are available for the OSA sensor, depending on need and the pusher system and/or retail display. Also, various and alternative sensor types can be used as the first and second sensors, for determining low or missing inventory on a shelf or product display. In embodiments, a suitable sensor is one that can determine how far (i.e., how empty) the existing products are from the back of the shelf or other display structure, or additionally or alternatively, how deep the product goes from a front of the shelf or other display structure. The sensors are not tied to a particular product or retail display structure. Suitable specific types of sensors can be proximity/distance sensors, reed sensors/switches, and/or loop sensors (e.g., induction loop sensors). As illustrated in FIG. 8, the first sensor 102 is desirably a reed switch and the second sensor 110 is desirably a time-of-flight (TOF) sensor, also known/available as a TOF camera. Alternative sensors are available for the first sensor include mechanical switches or firmware/software stock level calculations. Out of stock detection can also be performed without a magnet at the front of the pusher, such as by using a calibration wand (e.g., a magnet on a stick) that saves/calibrates the out-of-stock position when the wand is touched to the sensor near the Reed switch when the pusher is in the empty position. Out of stock detection can also be done using software by saving the sensor TOF value with the pusher in the out-of-stock position.

FIGS. 9 and 10 show an OSA sensor 120 according to embodiments of this invention. The OSA sensor 120 includes a housing 122 having a separable top cover 124 and bottom cover 126. In embodiments, removing the top cover 124 from the bottom cover 126 allows access to internal components for OSA sensor setup. The OSA sensor 100 includes a Reed switch 130 and a TOF sensor 140. An alignment element, shown as a bar extension 128, extends from the bottom cover 126 for aligning with respect to (i.e., partially above) the product pusher. An adhesive material 150 is used to secure the OSA sensor 100 to the corresponding product pusher, such as in the position shown in FIG. 8.

In embodiments of the invention, the shelf stock sensor readings can be used by the central control unit to calculate inventory, both locally on the shelf and throughout the store. In some embodiments, the sensors can determine both full, partially empty, and fully empty product displays. Inventory measurements can be provided in number of units removed or remaining, a percentage of unit removed or remaining, or any suitable measurement. Preferably, the shelf stock sensors also can be used by the central control unit to determine theft events, such as during sweep events. As an example, if the shelf stock sensor, or many adjacent shelf stock sensors indicate a quick, unexpected reduction in product, the central control unit can determine a theft event, and automatically alert and/or lock adjacent and/or similar product displays. Such a lockdown can be done by product type, by anti-theft device type, department-wide, or storewide, etc.

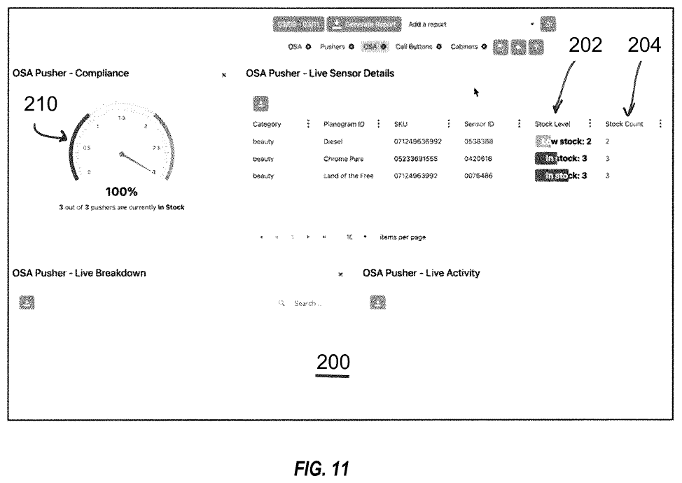

FIG. 11 illustrates a representative GUI display 200 from the central control unit, for three pushers. Each of the pushers includes a category and identification information as discussed above. Each pusher further includes a stock level indicator 202 and stock count number 204, as measured and transmitted by the respective OSA sensor. A general pusher compliance indicator 210 is shown for quick reference to the overall stock health of the pushers, which can be useful for staff to know whether further review of individual pushers is needed.

In embodiments, the shelf stock sensor readings can also be used by the central control unit to calculate various sales information. For example, the timing of the product depletion, whether time of day, day of month, etc. can be used to plan for future inventory management.

In embodiments, sensor installation and calibration includes installing a battery and affixing the OSA sensor to the pusher bar plate so that the TOF sensor peeks over the top of the pusher plate and can ‘see’ the back wall of the display/shelf. A magnet is installed at the front of the pusher so that the reed switch on the OSA sensor is triggered reliability when the pusher is emptied of all stock. A reed switch active event is triggered by removing all stock (pusher ‘empty’ event). The empty TOF distance will be automatically calibrated in the host system. The pusher is loaded with a full stock of items (max number of items), and the ‘full’ TOF range/distance is reported along with the number of items present. This along with the product thickness/depth can be used to update the host system. The current number of items in-stock should now be displayable in the system portal in real-time.

In embodiments of this invention, the OSA sensor operation includes placing the sensor on the pusher in the desired location and separating the top and bottom covers. Upon this action, and for a predetermined time period (e.g., 5 minutes) thereafter, the OSA sensor will automatically check the range from pusher bar to rear of display/shelf approximately every 10 seconds if no motion is detected. If motion is detected, the sensor will check range immediately. If the range has changed from last reading, a message will be transmitted with the new range. A first LED will flicker if there is a new range detected from last reading. A second LED will flicker if sensor motion is detected. The second LED will flash if there is a range detection error (e.g., there is no reflective surface within 4 feet to return a ranging signal). A third LED will flicker if a message is transmitted to the host system with a new range data. The third LED will remain solid if a magnet for the reed switch is detected. In embodiments, each count TOF range/distance unit is approximately equal to 5 mm (0.197 inches). Desirably a minimum range from the sensor to rear (reflective) wall is about 1 cm, and a maximum range is about 127 cm (˜50 inches/4.1 feet). With the sensor top cover in place for more than 5 minutes, the TOF sensor will: 1) check the range from the pusher bar to rear of display/shelf at predetermined intervals (e.g., approximately every 10 minutes), or within a quicker interval (e.g., 2 seconds) if motion is detected. If the range has changed from a last reading, a message will be transmitted to the host system with the new range.

In embodiments, the OSA sensor triggers at least two and desirably all of the following events: out-of-stock event, on reed switch activated; in-stock event, on reed switch inactivated; still-out-of-stock event if the pusher is out of stock and the sensor has been inactive for a predetermined time (e.g., 70 minutes); a still-in-stock event if the pusher is in stock and the sensor has been inactive for the time (70 minutes); and a sweep theft event for 3 out-of-stock events within 15 seconds. Data is sent to the hoist system portal for all of the above events, and the event history can be viewed on a per-sensor basis. Custom audio can desirably be created and assigned to any of the above events via the host system. SMS notifications can be registered to phone numbers for the above events. An OSA sweep theft event can be configured in the host system to lock all elocks (if there are any in the store).

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A retail product monitoring system, comprising a sensor for detecting a product availability on a retail product display.

2. The system according to claim 1, wherein the sensor is connected to a moveable product pusher, and determines the product availability as a function of movement of the product pusher.

3. The system according to claim 2, wherein the sensor determines a distance from a front or a rear of the retail product display.

4. The system according to claim 1, wherein the sensor determines a distance from a retail product to a front or a rear of the retail product display.

5. The system according to claim 1, wherein the sensor comprises a first sensor and a second sensor enclosed in a housing.

6. The system according to claim 5, wherein the first sensor determines an empty retail product display, and a second sensor determines a distance from a front or rear of the retail product display.

7. The system according to claim 6, wherein the first sensor comprises a Reed switch and the second sensor comprises a time-of-flight (TOF) sensor.

8. The system according to claim 5, wherein the housing is connected to a moveable product pusher of the retail product display.

9. The system according to claim 8, wherein the housing is adhered to the moveable product pusher of the retail product display.

10. The system according to claim 1, wherein the sensor comprises a magnet disposed at a front of the retail product display.

11. The system according to claim 1, further comprising a central control unit including a user interface configured to receive sensor information and display or alert a low inventory indication and/or a current number of product items on the retail product display.

12. The system according to claim 11, further comprising a plurality of configurable anti-theft devices connected with respect to the central control unit, wherein the sensor and each of the plurality of configurable anti-theft devices is added, removed, moved, changed, and/or modified through the user interface, and wherein the plurality of configurable anti-theft devices comprises a shelf availability sensor.

13. The system according to claim 12, wherein the plurality of configurable anti-theft devices includes combinations of sensors, locks, call buttons, gates, safes, and retail cabinets distributed through a retail store, and the user interface monitors and displays operation data related to the plurality of configurable anti-theft devices.

14. The system according to claim 11, wherein the user interface is configured to monitor and control the sensor and the plurality of configurable anti-theft devices and allow retail users to respond to customers and alerts from the each of the plurality of configurable anti-theft devices directly and in person or through additional electronic inputs.

15. The system according to claim 11, wherein the sensor and each of the plurality of configurable anti-theft devices includes a unique identification stored within the central control unit.

16. The system according to claim 15, wherein the sensor and the each of the plurality of configurable anti-theft devices is assigned a retail category according to a location within the retail environment.

17. The system according to claim 16, wherein the retail category is selected from the group consisting of jewelry, fragrance, electronics, tools, medicine, weaponry, and a specific product brand.

18. The system according to claim 11, wherein the user interface is accessible on each of a plurality of portable access devices useable throughout the retail environment.

19. The system according to claim 12, wherein the plurality of configurable anti-theft devices can be collectively locked and unlocked by retail product type through the user interface.

20. A method of securing products in a retail environment, the method comprising:
associating one or more products with the sensor of claim 1 in wireless connection with a central control unit including a user interface; and
identifying the sensor with a category selected from device type, retail product type, and/or product location within the retail environment.
